(19) United States
(12) Patent Application Publication
(10) Pub. No.: US 2023/0309460 A1
(43) Pub. Date: Oct. 5, 2023

(54) AGRO-PHOTOVOLTAIC MODULE

(71) Applicant: BING KLIMA LTD, Gedera (IL)

(72) Inventors: Oded SHAMIR, Gedera (IL); Yuval SHAMIR, Gallilee (IL)

(21) Appl. No.: 18/024,521

(22) PCT Filed: Sep. 12, 2021
(86) PCT No.: PCT/IL2021/051105

§ 371 Date: Mar. 3, 2023

(30) Foreign Application Priority Data
Sep. 13, 2020 (IL) 277321

(51) Int. Cl. A01G 9/02; A01G 27/02; A01K 63/04; H02S 10/40

(52) U.S. Cl. CPC A01G 9/02; A01G 27/02; A01K 63/04; H02S 10/40

(57) ABSTRACT

The presently disclosed subject matter refers to agro-photovoltaic modules (at times also referred to as agri voltaic modules) designed to increase the productivity use of available area. The agro-photovoltaic module can enable agricultural growth and the production of energy, e.g. by using photovoltaic cell(s), while using the same area (land space, lake, rooftop, etc.), therefore the agro-photovoltaic module can offer a good solution for this issue. This may help overcome legislations/rules in different countries, for example, where land can not be used solely for solar energy cultivation and must be integrated with agricultural purposes. The produced photovoltaic energy is either being used by components of the module or directed to an external electric power system.

### TECHNOLOGICAL FIELD

The presently disclosed subject matter relates in general to the field of agro-photovoltaic modules, and more particularly to the field of units enabling the growth of plants and the production of photovoltaic energy.

### BACKGROUND

Available land space is becoming a scares commodity, in the countryside as well as in large cities. Recently, people have started noticing the value of organic agricultural products and are therefore looking for ways to grow their own vegetables. Therefore, people in many of the cities around the world have started to grow vegetables and/or groom a small garden on their rooftops. In order for the rooftop garden to flourish, the agricultural growth need to receive sunlight, water and of course a proper growing bed. Accordingly, personal small units allegedly provide these conditions to enable an individual growing unit on rooftops. Additionally, farmers worldwide are always seeking ways to increase their yield, and therefore have stared to incorporate different types of plants to maximize available land space. In the energy sector it is common to see photovoltaic cells over water reservoirs for exploiting these areas for the production of energy, while not taking up space in other places.

Since the use of available land is becoming a scarce commodity there is the need to use it wisely. Both energy and agricultural products are of great importance for people worldwide and therefore the “battle” between the use of available land for agricultural purposes or for the production of photovoltaic energy can be seen in many places.

For example, US patent application 2015/082697 discloses a low-maintenance and water-conserving container-gardening system used indoors or outdoors to grow plants, vegetables, herbs, fruits, and flowers. This system uses one or more gardening containers each having water-elevating structure causing slow and consistent upward flow of nutrient/fluid into the soil, and nutrient/fluid drainage-facilitating structure that directs surplus nutrient/fluid away from plant roots when the pump stops. The system uses solar panels to supply energy to the pump.

CN 209861787 utility model discloses a cultivation device for vegetable seedling raising. A water tank is arranged at the bottom of the box body; a plant light supplementing lamp and a telescopic device are arranged at the top in the box body; a humidity sensor is arranged at the bottom in the seedling tray. A solar cell panel is arranged at the upper end of the supporting rod, providing energy locally, e.g. to the light, which is positioned within the box, sensor and motor.

Acknowledgement of the above references herein is not to be inferred as meaning that these are in any way relevant to the patentability of the presently disclosed subject matter.

### GENERAL DESCRIPTION

The presently disclosed subject matter refers to agro-photovoltaic modules (at times also referred to as agrivoltaic modules) designed to increase the productivity use of available area. The agro-photovoltaic module can enable agricultural growth and the production of energy, e.g. by using photovoltaic cell(s), while using the same area (land space, lake, rooftop, etc.), therefore the agro-photovoltaic module can offer a good solution for this issue. This may help overcome legislations/rules in different countries, for example, where land can not be used solely for solar energy cultivation and must be integrated with agricultural purposes.

In some embodiments, the agro-photovoltaic module is mobile, at least when empty, and it can be easily shipped around the world and relocated at any desired location. The mobile agro-photovoltaic module can be easily moved according to farmers needs or the unique landscape of any location or it can be positioned on rooftops and/or water reservoirs, etc.

Accordingly, the present subject matter discloses an agro-photovoltaic module comprising: a growing tray having a bottom surface and circumferential side walls, configured to facilitate a growing bed for enabling the growth of one of plants or animals; and a photovoltaic cell positionable over said growing tray, configured to produce photovoltaic energy.

The produced photovoltaic energy is either being used by components of the module or directed to an external electric power system. In some embodiments, a majority of said produced photovoltaic energy is directed to an external electric power system. In some embodiments all of the produced photovoltaic energy is directed to an external electric power system.

The agro-photovoltaic module according to the presently disclosed subject matter has a number of unique features and/or elements identified below in different aspects of the presently disclosed subject matter, each of which contributes in its way to the ability of the module to operate under different conditions and/or to enable production of photovoltaic energy such that, optionally, a majority of which is directed for use of an external electric power system along with the growth of different agricultural products which may require different growing beds, such as solid/semi-solid/semi-liquid/or even hydroponic and/or aquaponic growth. The features of the module according to different aspects identified below and also other features described in Detailed Description of Embodiments can be combined with each other in any combination in accordance with further aspects of the presently disclosed subject matter.

The two basic elements that the agro-photovoltaic module comprise are the growing tray and the photovoltaic cell. The growing tray can be configured for facilitating a growing bed, such as soil, manure, tuff, perlite, peat or alike, which may enable agricultural growth, such as of plants, e.g. vegetables, flowers, shrubs, vines, climbing plants, poultry, bees or alike. The growing tray can have a bottom surface and circumferential side walls which can define a basin capable of facilitating the growing bed therein. The photovoltaic cell can be positioned over the growing tray, thereby increasing the direct line of sight with sunlight or artificial lighting. Being positioned above the growing tray, can also enable the photovoltaic cell to shelter the plants growing in the growing tray. For example, reduce the exposure of the plants to direct sunlight, e.g. particularly during mid-day, i.e. the hottest hours of the day. Additionally, the photovoltaic cell may also shelter the plant, e.g. during heavy rains, which may be harmful to delicate plants such as flower or herbs.

The photovoltaic cell is configured to produce photovoltaic energy, with at least a majority of the produced photovoltaic energy directed to an external electric power system, which can be external with respect to the elements comprising the agro-photovoltaic module, e.g., an external power grid, a battery, an end user any combination thereof and/or any other electrical energy transporting, consuming and/or storing devices. Accordingly, the photovoltaic cell can produce more energy than required and/or consumed by the agro-photovoltaic module, thereby at least the majority of the produced photovoltaic energy may not be intended for powering energy related elements of the module, such as internal lighting, motors, pumps etc.

The agro-photovoltaic module can further comprise a water collecting tank, which can be configured to hold liquid therein, such as water and/or liquid fertilizers. The water collecting tank can have circumferential side walls, such that the growing tray can be contained therebetween or nested therein. The water collecting tank can be positioned under the growing tray, thereby enabling water to drain from the growing tray to the water tank. Additionally, excess rainwater or irrigation water can also be collected in the water tank. Water stored in the water tank may, for example, be used to water the agricultural products growing within the growing tray of the module and/or neighboring modules or other agricultural products, thereby preserving water usage.

The water collecting tank, when filled with water, can affect the ambient environment conditions of the module. The passive heating and cooling of the water collecting tank maintain balanced temperatures in the proximity surrounding of the module.

According to an aspect of the presently disclosed subject matter, the growing tray can be configured for stackable nesting into like growing trays. The water collecting tank can be configured for stackable nesting into like water collecting tanks or wherein the growing tray can be configured for stackable nesting into the water collecting tank, or vise versa.

A stackable nesting arrangement of the agro-photovoltaic module requires a small footprint, e.g. when stored as one module or upon storing multiple modules together, thereby reduce storage and shipping costs.

According to an aspect of the presently disclosed subject matter, the photovoltaic cell can be detachably attachable to the growing tray and/or the water collecting tank. When attached, the growing tray and the water tank can comprise a bottom unit which can be detachably attachable to the photovoltaic cell. Detaching the photovoltaic cell, or other elements, from the module may enable stackable nesting the elements into like elements of like modules, such as the growing trays or water collecting tanks, which may then, be stacked together.

According to an aspect of the presently disclosed subject matter, the agro-photovoltaic module as a whole, or as part of a system comprising at least two agro-photovoltaic modules can float on water, such as a water reservoir, e.g. lakes, fish ponds, treated or rain collecting water reservoirs or like reservoirs. This can be achieved due to the design of the module or parts thereof, e.g. by having a floating design, the material used during production, such as floatable material or by using a floating arrangement which may be connected and/or be part of the agro-photovoltaic module as a whole or to any part thereof. Alternately, the agro-photovoltaic module can be positioned over a support system within the water.

According to a particular embodiment, the growing tray can be configured to float on the stored water in the water collecting tank. This can enable the growing tray to be easily rotated with respect to the water collecting tank, i.e. since the friction factor is reduced by the stored water. In some embodiments, e.g. when the agro-photovoltaic module may not float properly (or at all), a system, comprising at least two agro-photovoltaic modules can be designed to float on water. For example, as a system, the agro-photovoltaic modules can form a floating design i.e. have the structural characteristics of a floating structure.

According to yet an aspect of the presently disclosed subject matter the photovoltaic cell can be connectable to the external electric power system. For example, the photovoltaic cell can be connected to the external electric power system directly or the photovoltaic cell can be connectable to like photovoltaic cells to form a series circuit, a parallel circuit or series of any combination thereof which may then be connected to the external electric power system as a circuit.

The growing bed can be any growing bed which suitable for growth of plants, such as soil, manure, tuff, perlite, peat or alike. The growing bed can be semi-liquid, moist or liquid which can enable hydroponic or aeroponic growth of plants or aquaponic growth of fish.

The growing tray can further comprise a side door for enabling easy access to the plants or growing bed. The door can be opened to facilitate a side entrance, thereby enabling a user an additional point of access to the plants or growing bed. The growing tray can have two doors or more, wherein the doors can be posited along the same side wall, or at different side walls, thereby enabling multiple access points to the plants and/or growing bed.

The agro-photovoltaic module as a whole, or any part thereof, can be mobile by hand, at least when empty. For example, the agro-photovoltaic module can be moved by a user without additional machinery-based assistance, such as a tractor and/or a forklift. The agro-photovoltaic can be secured to the ground, e.g. by stakes, wedges and/or ropes, to prevent it from unintentional movement, at least until it may be filled with the growing bed or water.

Positioning of the agro-photovoltaic can be done, for example, based on environmental conditions of each area. For example, upon positioning of the agro-photovoltaic module or part thereof at a desired location, the user can take into consideration the amount of sheltering required for the plants growing within the growing tray and/or the amount of direct sunlight desired for the photovoltaic cell. Accordingly, the user may choose to position the agro-photovoltaic such that the photovoltaic cell may shelter the growing tray as much as possible, or vice versa. In some embodiments, an optimization program may recommend the desired angle the photovoltice cell should be positioned, so that as much as direct sunlight will reach the photovoltaic cell while sheltering the plants as much as required.

The module or any part thereof can be mobile, even when full of water and/or growing bed, by a forklift, a tractor or any other agricultural or industrial machinery. In most cases after the agro-photovoltaic has been filled with the growing bed or water, or when plants have started to grow, its total weight may prevent unintentional movement. Nonetheless, when necessary to reposition the agro-photovoltaic, e.g. due to change of weather or the scenery (such as shading of a new tree or building), or when the farmer wants to change the system location due to changes in the fields layout, or any other reason, agricultural or industrial machinery, such as forklifts, tractors, trucks or cranes may be of such an assistance.

The growing tray, the solar panel or both, can be rotatable with respect to the water tank. For example, after positioning the agro-photovoltaic module at its location, any one or both of the growing tray and the solar panel can be pivoted according to the movement of the sun through the day. For example, to increase production of the photovoltaic cell, which may be detachably attachable to the growing tray, and/or to increase the plants exposure to the sun, e.g. during winter. This “following the sun” function may be done manually or by a mechanical apparatus such as a motor or a piston, etc., according to a predetermined program, such as a computer program/algorithm or other predefined algorithm, configured to optimize the production of energy and/or agricultural growth. The rotation and/or pivoting of the growing tray with respect to the water tank may be done by a motor and/or manually. As detailed hereinabove the growing tray can float on the liquid stored within the water tank (e.g. water, liquid fertilizers, etc.), when doing so the friction between the growing tray and the water tank may be reduced, thereby enabling the rotation and/or pivoting to be completed by using less force than otherwise required.

According to an aspect of the presently disclosed subject matter there is provided a system comprising at least two agro-photovoltaic modules as described hereinabove, wherein the photovoltaic cell of each of the modules can be connectable to the external electric power system. It should be noted that when forming a system of agro-photovoltaic modules. In some embodiments, the photovoltaic cells are connected to form a series circuit, a parallel circuit or series of any combination thereof which may then be connected to the external electric power system thereby increasing the voltage or current produced by the system, e.g. according to the requirements of the external electric power system.

Any one or more of the following features, designs and configurations can be applied to the agro-photovoltaic module by its own or as part of a system according to any aspect of the present disclosure, separately or in various combinations thereof:
All of the produced energy in the agro-photovoltaic module is directed for use of an external power system;
The photovoltaic cell of the agro-photovoltaic module is positionable over the growing tray by poles, rods, stacks or any other element which may secure the photovoltaic cell above the growing tray;
The agro-photovoltaic module or any part thereof is made out of plastic (polymeric material), or any other manipulated material;
The agro-photovoltaic module or any part thereof is made of plastic (polymeric material), or any other material that is configured to float on water;
The growing tray is divided into multiple individual growing units;
The growing tray and/or each individual growing unit have holes enabling excess of water from the water tank when submerged into the water tank, to enable hydroponic growth;
The growing tray and/or the water collecting tank is formed by using a Rotation Molding technique;
The growing tray and/or the water collecting tank may be formed by using a direct injection technique with or without the use of vacuum;
The photovoltaic cell of the agro-photovoltaic module is used to produce DC or AC currents;
The water tank has at least one water port, such that it is able to receive water directly from a water line via one of the water ports and to enable water flow to like water tanks or to the next module via a second water port;
The water tank comprises a lifting lever along an external side of the water tank to enable easy lifting of the agro-photovoltaic module, bottom unit and/or water tank;
The bottom surface of the growing tray is inclined towards a drainage port to enable drainage of excess water from the growing tray to the water collecting tank;
The drainage port comprises a filter, such as gravel filter, sand filter, carbon filter, membraned filter or any other sort of water filter, that insures that at least a majority of the growing bed does not enter the water tank;
The agro-photovoltaic module assumes any polygonal (such as a hexagon, symmetric or not), or round, or hybrid shape;
The module has a general shape of a rectangular or a hexagon. When a single agro-photovoltaic module is generally shaped as a hexagon, a system comprising multiple modules may have a general shape of a hive.
The module comprises one or more water ports for allowing flow of water between the water collecting tank and at least one of like water collecting tanks, growing trays, a water feeding line and/or a big collection water tank. The flow of water is either (i) unidirectional, namely that the flow occurs only from the collecting tank or only into the collecting tank, or (ii) bi-directional, such that water can flow from and into the collecting tank;
The module is connectable to like photovoltaic cells to form a series circuit, a parallel circuit or series of any combination thereof;
The module is connectable to a like agro-photovoltaic module either through liquid communication by one or more water ports or through an electrical connectivity in series or parallel, or through a combination of the two connection types.
The module or a system that comprises a plurality of connected modules is connectable via a first port to a first water source including biological matter, e.g. a water source for fish growing, and via a second port to a second water source to discharge processed water after passing through the growing trays and some of the biological matter is being absorbed by the growing plants. In some embodiments, the module or the plurality of modules in the system comprise one or more pumps for circulating water from the water collecting tank to the growing tray.
The growing tray is configured to provide a growing bed for animals, such as poultry and bees. The biological matter produced by the animals is discharged to the water below the growing tray, in which fish can be grown and use the discharged biological matter.
The photovoltaic cell of the module is two-sided photovoltaic cell. In other words, the photovoltaic cell is configured to receive electromagnetic radiation from two faces and transform it to electric power.
The module further comprises one or more sensors for sensing at least one of: temperature, humidity, water level in the collecting tank and state of the photovoltaic cell. The module further comprises a processing circuitry for controlling at least one of: water inflow/outflow of the system, water properties such as: temperature, EC, pH etc., climate conditions and photovoltaic cell state in response to the measurement received by said one or more sensors.
The photovoltaic cell is inclined to define a bottom part of the photovoltaic cell. The bottom part of the photovoltaic cell comprises a water draining element for draining the water flowing over the photovoltaic cell and direct them to either the water collecting tank or the growing tray.
The water is used to clean the photovoltaic cell and circulated to the water collecting tank or the growing tray.
The module further comprises a perforated cover mounted on the growing tray. The perforations of the cover are configured for fitting over the plants in the growing tray to allow them to be exposed to the environment, e.g. to sunlight. The cover is used to prevent evaporation of water from the water collecting tank below the growing tray. In some embodiments, the perforated cover comprises a photovoltaic facing face that comprises or coated by a reflecting material that is configured to reflect a selected range of electromagnetic radiation. The reflected radiation can be received by the plants abutting from the perforations or by the photovoltaic cell, when it is configured as a two-sided photovoltaic cell.
Wherein a majority of said produced photovoltaic energy is directed to an external electric power system.
Wherein said majority of produced photovoltaic energy is not intended for powering energy related elements of said module.
Wherein said external electric power system is an external power grid.
Wherein said external electric power system is a battery or any other electrical energy storing device.
The photovoltaic cell is detachably attachable to said module or any part thereof.
The growing tray further comprises watering tunnels for providing constant water supply to plants growing thereon, wherein the watering tunnels define growing spots for the plants.
The growing tray further comprises watering tunnels for providing constant water supply to plants growing thereon and the perforations of the perforated cover are arranged along the watering tunnels to define growing spots for plants.
The water collecting tank can be configured for growing of fish therein, namely contain essential environmental conditions for growing fish.
The agro-photovoltaic module is mobile.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a schematic illustration of an agro-photovoltaic module having a general rectangular shape, according to an example of the disclosure;

FIG. 1B is a schematic exploded illustration of the agro-photovoltaic module illustrated in FIG. 1A, according to an example of the disclosure;

FIG. 1C is a schematic illustration of construction of a bottom unit of the agro-photovoltaic module illustrated in FIGS. 1A and 1B, according to an example of the disclosure;

FIG. 2A is a schematic cross section illustration of a bottom unit of the agro-photovoltaic module, according to an example of the disclosure;

FIG. 2B is a schematic cross section illustration of a hydroponic growing tray and a water collecting tank where the plant roots grow, of an agro-photovoltaic module, according to an example of the disclosure;

FIG. 3 is a schematic cross section illustration of stackably nesting two bottom units of the agro-photovoltaic module illustrated in FIGS. 1A to 1C, according to an example of the disclosure;

FIG. 4A is a schematic illustration of an agro-photovoltaic module having a general hexagon shape, according to an example of the disclosure;

FIG. 4B is a schematic exploded illustration of the agro-photovoltaic module illustrated in FIG. 4A, according to an example of the disclosure;

FIG. 5A is a schematic illustration to a water collecting tank of the agro-photovoltaic module illustrated in FIGS. 4A and 4B, according to an example of the disclosure;

FIG. 5B is a schematic illustration of a growing tray divided into multiple individual growing units, of the agro-photovoltaic module illustrated in FIGS. 4A and 4B, according to an example of the disclosure;

FIG. 6A is a schematic illustration of an agro-photovoltaic module having a pivotable bottom unit, according to an example of the disclosure;

FIG. 6B is a schematic exploded illustration of the agro-photovoltaic module illustrated in FIG. 6A, according to an example of the disclosure;

FIG. 6C is a top front view of the schematic exploded illustration of FIG. 6B, according to an example of the disclosure;

FIG. 7 is a schematic illustration of a system of the agro-photovoltaic modules illustrated in FIGS. 1A and 1B disposed in a field, according to an example of the disclosure;

FIG. 8 is a schematic illustration of a system of the agro-photovoltaic modules illustrated in FIGS. 4A and 4B positioned on top of a roof of a building, according to an example of the disclosure; and

FIGS. 9A-9C are schematic illustrations of different views of a non-limiting example of the agro-photovoltaic module according to an aspect of the present disclosure. FIG. 9A is a perspective view; FIG. 9B is a side view; and FIG. 9C is a longitudinal cross-sectional view.

### DETAILED DESCRIPTION OF EMBODIMENTS

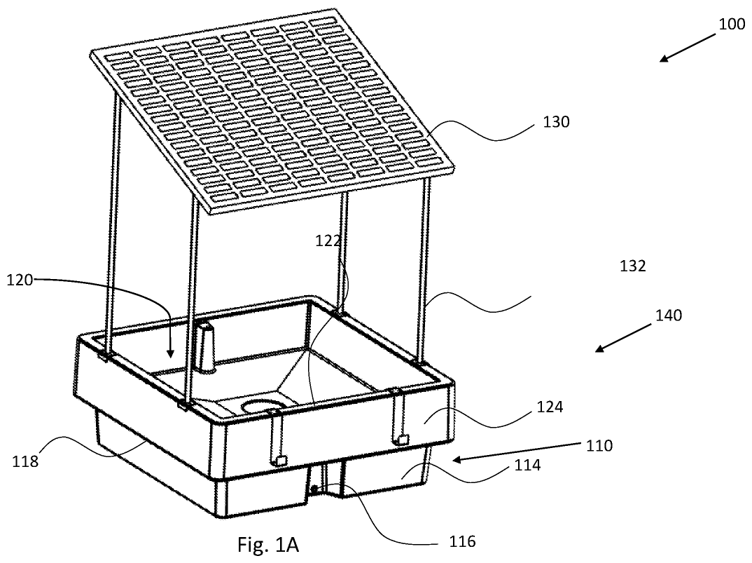

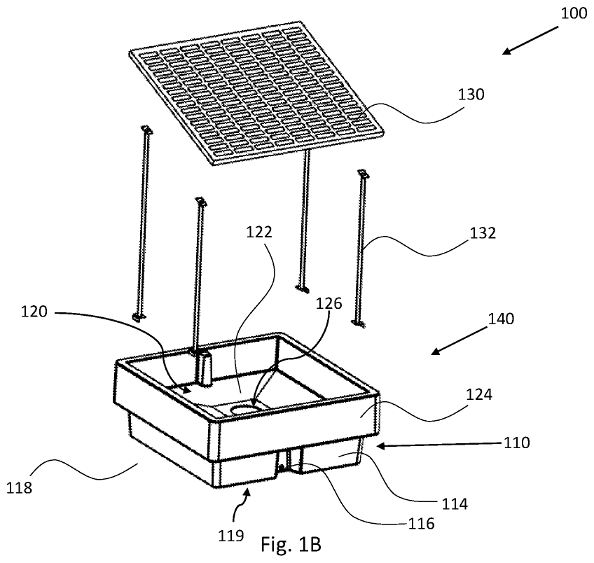

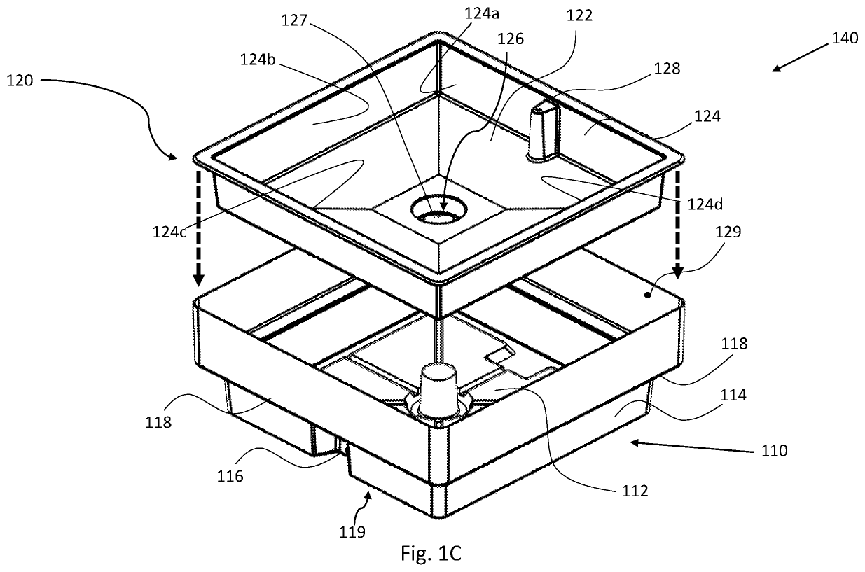

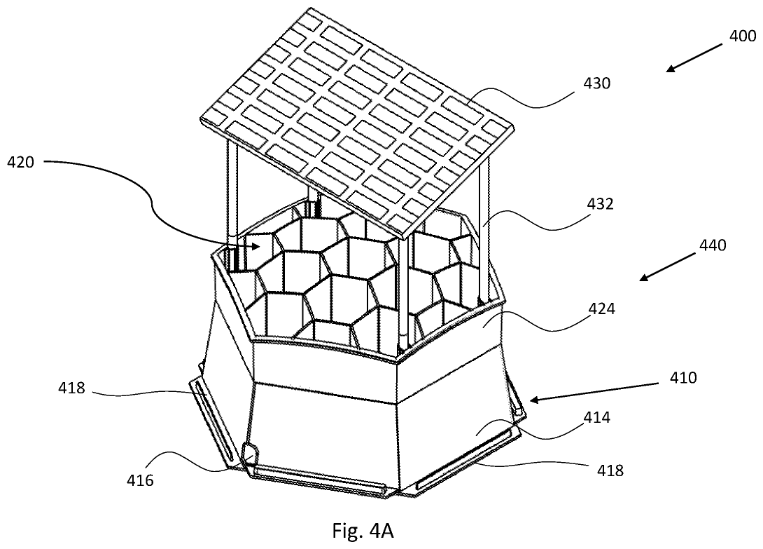

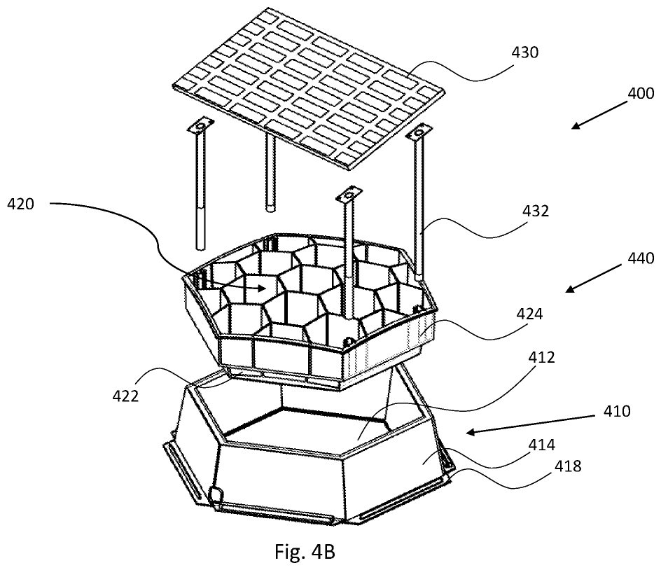

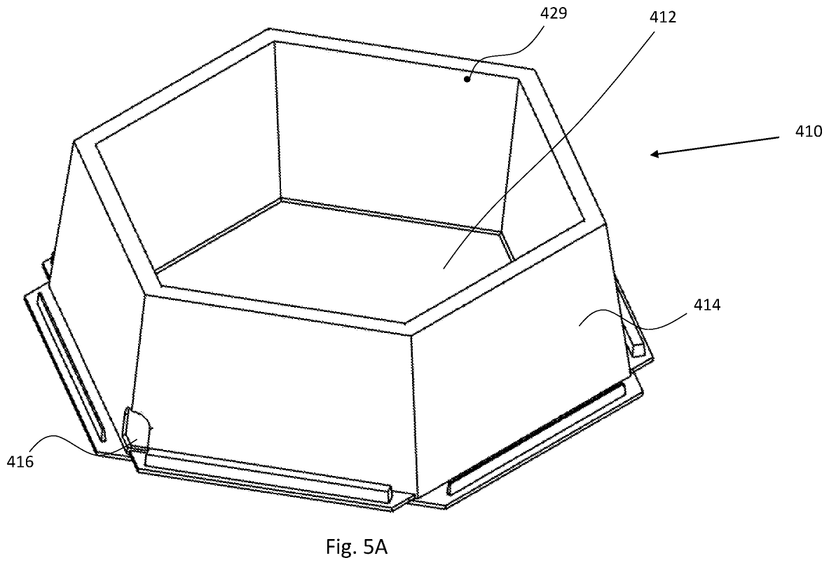

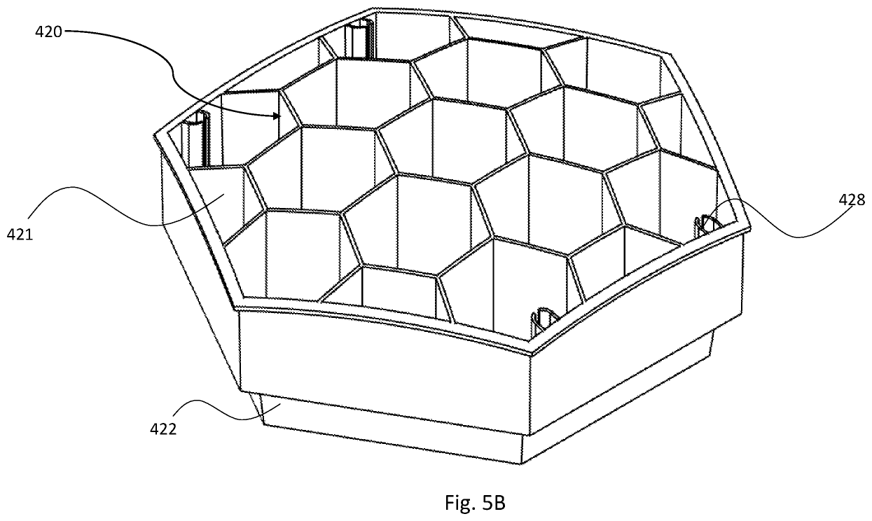

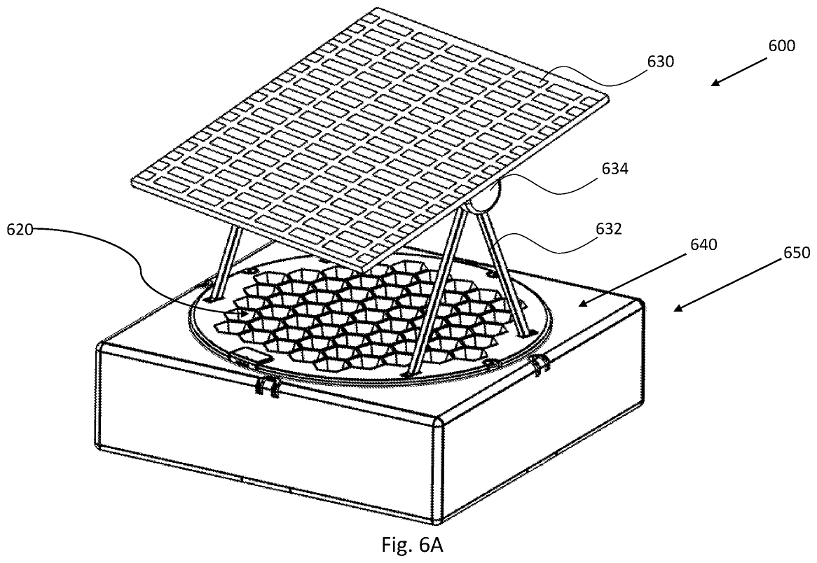

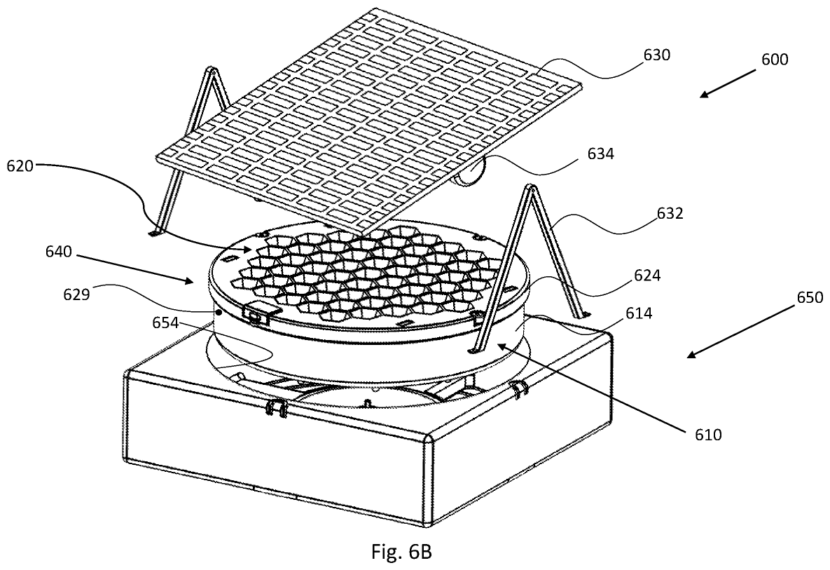

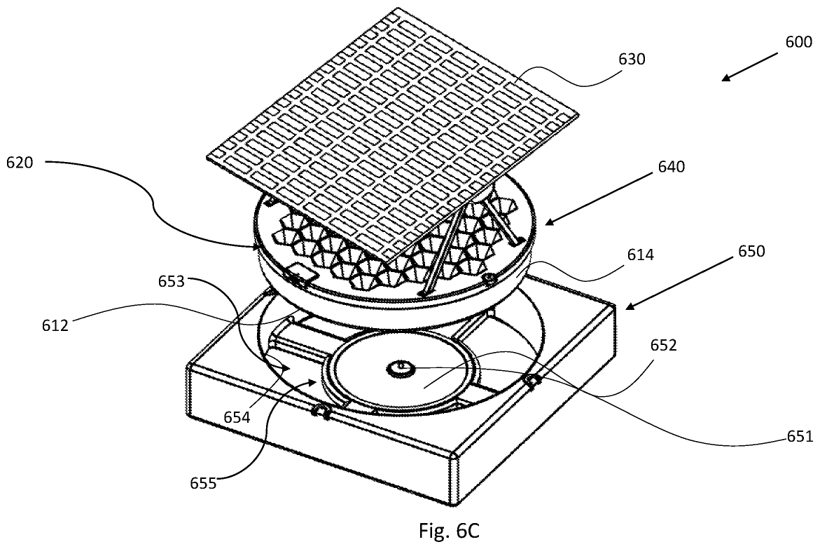

Reference is now made to FIGS. 1A to 1C which schematically illustrate an agro-photovoltaic module generally designated 100 having a general rectangular shape, according to an example of the disclosure. In the illustrated example the agro-photovoltaic module 100 is rectangular, this being a mere example, whereas the agro-photovoltaic module can assume any polygonal (such as a hexagon illustrated in FIGS. 4A to 5B, symmetric or not), or round, or hybrid shapes (as illustrated with respect to FIGS. 6A to 6B). Likewise, other elements of the agro-photovoltaic module have a corresponding rectangular shape, as a result of present examples employing a rectangular agro-photovoltaic module.

The agro-photovoltaic module 100 comprises a growing tray 120 having a bottom surface 122 and circumferential side walls 124 defining a basin, configured to facilitate a growing bed therein (not illustrated) for enabling the growth of plants, a photovoltaic cell 130 is positionable over the growing tray 120, e.g. by rods 132, configured to produce photovoltaic energy, such that a majority of the produced photovoltaic energy is directed to an external electric power system (not illustrated), and a water collecting tank 110 positioned beneath the growing tray 120 configured to store water therein. The stored water in the water tank 110 can be used to water the agricultural products growing within the growing tray 120 or other agricultural products, thereby preserving water usage. The water tank 110 has circumferential side walls 114, such that the growing tray 120 is supported by side walls 114 e.g. when nesting within water tank 110. It should be noted that although the agro-photovoltaic module 100 comprises the water collecting tank 110 the two basic elements of the module are the growing tray 120 and the photovoltaic cell 130. In some embodiment all of the produced photovoltaic energy is directed to an external electric power system.

The growing bed can be introduced into the growing tray 120, to enable agricultural growth of plants, e.g. vegetables, flowers, shrubs or alike. Accordingly, the growing bed can be any solid or semi-solid growing bed, such as soil, manure, tuff, perlite, peat or alike. The growing bed is supported by the bottom surface 122 and by the side walls 124 of the growing tray 120. The bottom surface of the growing tray 122 is inclined towards a drainage port 126 to enable drainage of excess water from the growing tray 122 to the water collecting tank 110. Excess water may result from rains, irrigation and/or use of growing bed which does not “hold” water. The drainage port 126 comprises a filter 127, such as gravel filter, sand filter, carbon filter, membraned filter or any other sort of water filter, that insures that at least a majority of the growing bed does not enter the water tank 110.

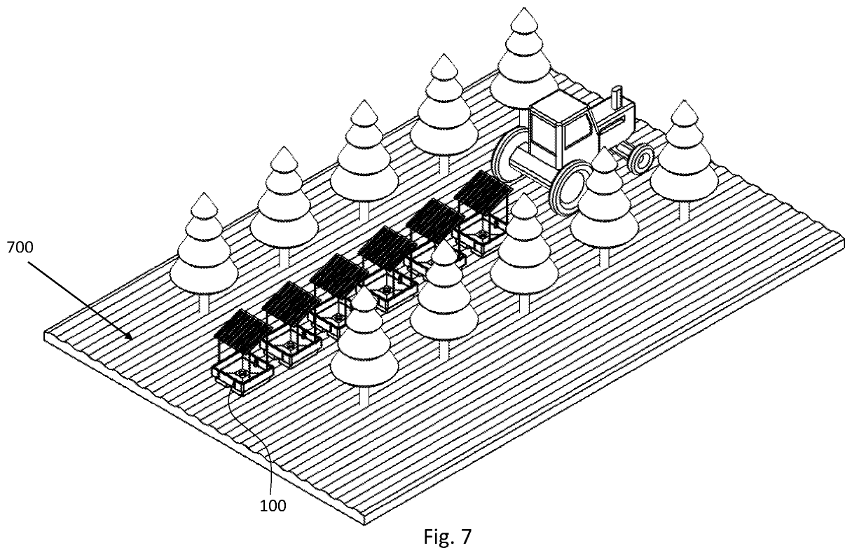

The water tank 110 can receive excess water form the growing tray 120 as detailed hereinabove or by a direct water line which can be connected to water port 116. Whereas water port 116 is configured to receive water into the water tank 110, e.g. via connection to a hose, an additional water port 116 (not illustrated) can be configured to enable flow of water to like water tanks, or to big water collection tank e.g. when forming a system of agro-photovoltaic modules 100, such as system 700 illustrated in FIG. 7. The water stored in the water tank 110 can be used for irrigation of the plants growing within the growing tray 120, e.g. through irrigation port 128. The stored water in the water tank 110 can “travel” to the irrigation port 128 by using the capillary lows, or by using a pump. It should be noted that the stored water in water tank 110 can also be used for irrigation of like growing trays of other agro-photovoltaic modules, e.g. when being part of a system. Air hole 129 is configured at an upper portion of the water tank 110 thereby enabling air to enter or exit the water tank 110. For example, upon water exiting the water tank 110, e.g. via irrigation port 128, to irrigate the plants in the growing tray 120, air must enter the water tank, e.g. via air hole 129. On the other hand, when filling up the water tank, via water port 116, air must exit the water tank 110, e.g. via air hole 129.

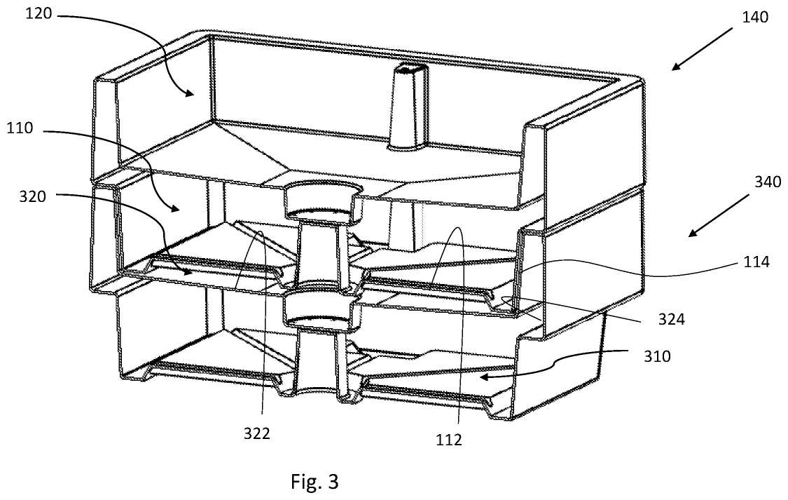

The photovoltaic cell 130 is detachably attachable to bottom unit 140 or any part thereof, e.g. the growing tray 120 and/or the water collecting tank 110, this is best illustrated with respect to FIGS. 4B and 5B. Detaching the photovoltaic cell 130 from unit 140, enables stackable nesting elements of like modules, such as like growing trays and/or like water collecting tanks as detailed with respect to FIG. 3. The photovoltaic cell 130 is positionable over the growing tray 120, at an upmost section of the module, to enable a direct line of sight with sunlight or artificial lighting. Additionally, by being positioned above the growing tray 120, the photovoltaic cell 130 shelters the plants growing in the growing tray 120, which reduces their exposure to direct sunlight. Reducing exposure to direct sunlight is mainly desired during mid-day, i.e. the hottest hours of the day. For example, having the plants sheltered from direct sunlight can help reduce the water vapor by 12-34%, thereby improving water usage. Furthermore, sheltering the plants can also be effective during heavy rains, hail, or hard weather which may be harmful to delicate plants, such as flower or herbs. As illustrated, the photovoltaic cell 130 is inclined towards the growing tray 120. This inclination helps guide rain or irrigation water, e.g. when using sprinklers, falling onto the photovoltaic cell 130 to reach the plants growing within growing tray 120, thereby ensuring that the plants receive the maximal amount of water available to the land pace occupied by the agro-photovoltaic module. This inclination, may also help guide rain or irrigation water falling onto the photovoltaic cell 130 to reach the water tank 110, e.g. for storage therein.

Furthermore, since the plants growing in the growing tray 120, may help maintain a more moderate temperature then the surrounding area, e.g. due to vapor of water from the plants, the efficiency of the photovoltaic cell 130, positioned directly above them, may be increased as a result of the more moderate temperature, e.g. by 4-6%. Therefore, positioning the photovoltaic cell 130 over the growing tray 120 may increase both agricultural efficiency and energy production efficiency.

The positioning of the agro-photovoltaic module 100, or at least the growing tray 120 and/or the photovoltaic cell 130, can be according to the environmental conditions. For example, upon positioning of the agro-photovoltaic module 100 at a desired location, a user may take into consideration the amount of sheltering required for the plants growing within the growing tray 120, and/or the amount of direct sunlight desired for the photovoltaic cell 130. In some embodiments, an optimization program may recommend the desired angle at which direct sunlight reaches the photovoltaic cell 130 with respect to the amount of sheltering required for the plants, according to the global positing of the agro-photovoltaic module 100.

It should be noted that the photovoltaic cell 130 is configured to produce more photovoltaic energy then required by the agro-photovoltaic module 100, e.g. when using a pump to propel the water from the collecting tank 110 to growing tray 120, or when using artificial internal lighting to increase lighting for the plants, motors for rotating or pivoting the growing tray 120 and/or the photovoltaic cell 130 etc. Therefor, at least a majority of the produced photovoltaic energy is directed to an external electric power system, which may be external with respect to the elements comprising the agro-photovoltaic module, e.g., an external power grid, a battery, an end user any combination thereof or any other electrical energy transporting, consuming or storing device(s). The photovoltaic cell 130 can be connectable to the external electric power system directly or the photovoltaic cell 130 can be connectable to like photovoltaic cells to form a series circuit, a parallel circuit or series of any combination thereof which may then be connected to the external electric power system as a circuit.

According to another aspect of the presently disclosed subject matter the growing tray 120 the solar panel 130 or both, may be rotatable with respect to the water tank 110. For example, after positioning the agro-photovoltaic module 100 at its location, the growing tray 120 may be pivoted according to the movement of the sun through the day, e.g. at least along a horizontal reference plane of agro-photovoltaic module 100. For example, to increase production of the photovoltaic cell 130, which may be rotated along with the growing tray 120, and/or to increase the plants exposure to the sun. This “following the sun” function may be done manually and/or by a motor, e.g. according to an optimization program, such as a computer program or other predefined algorithm, configured to optimize the production of energy and/or agricultural growth. In some embodiments, the growing tray 120 can be configured to float on the water stored within the water tank 110, when doing so the friction between the growing tray 120 and the water tank 110 may be reduced thereby enabling the rotation and/or pivoting to be completed by using less force than otherwise required.

Although not illustrated, the growing tray 120 can comprise a side door for enabling easy access to the plants or growing bed. The door may be opened to facilitate a side entrance thereby enabling a user an additional access point to the plants or growing bed, e.g. for replacing the growing bed. In some embodiments, the growing tray 120 can have more than one side door, e.g. two doors or more. When comprising more than one side door, the doors may be posited along the same side wall 124, e.g. at opposite ends of the same side wall, or at different side walls 124a, 124b, 124c or 124d, thereby enabling multiple access points to the plants and/or growing bed.

According to an aspect of the presently disclosed subject matter, the agro-photovoltaic module 100, or any part thereof, is mobile by hand, at least when empty. For example, the agro-photovoltaic module 100 can be moved by a user without additional assistance such as a forklift. Accordingly, the user may place the agro-photovoltaic module 100 in its designated location, which may be out in an open field or on top of a roof. Accordingly, when empty, or when placed at a windy location it may be advised to secure the agro-photovoltaic to the ground, e.g. by stakes, wedges and/or ropes, to prevent it from unintentional movement, at least until it may be filled with the growing bed or water or sheltered from the wind. In other embodiments, e.g. when the agro-photovoltaic module 100 as a whole may weigh over 100 kg, the module may not be mobile by hand.

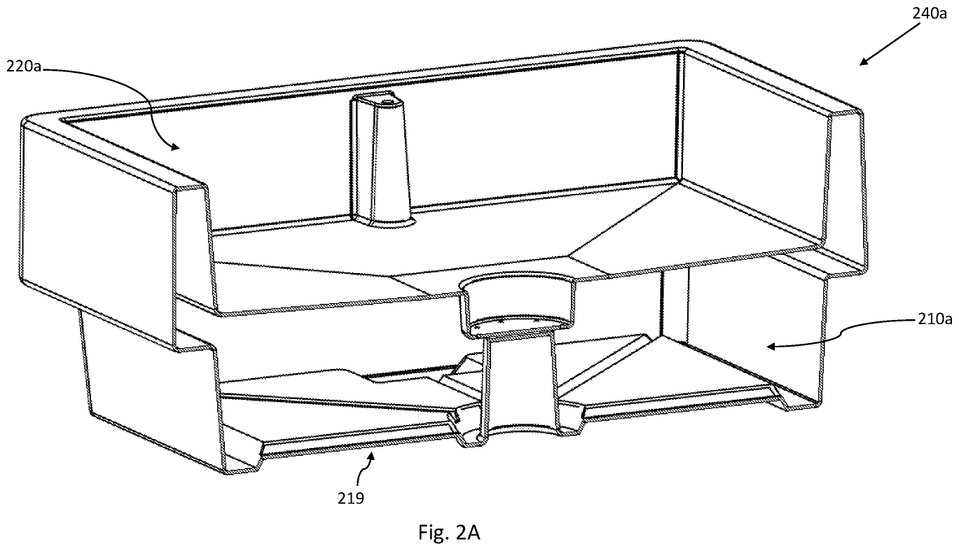

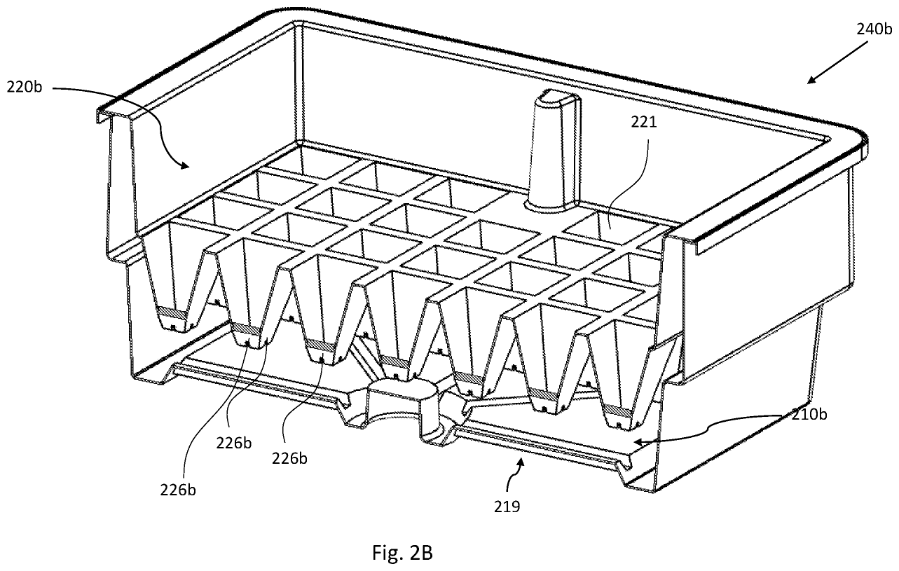

According to an aspect of the presently disclosed subject matter, the agro-photovoltaic module 100 or any part thereof can be mobile, even when full of water and/or growing bed, e.g. by a forklift, a tractor or any other agricultural or industrial machinery. For example, water tank 110 comprises grooves 119 disposed at its bottom section (illustrated best in FIGS. 2A and 2B as grooves 219). The grooves 119 enable forks of a forklift to easily elevate, move and/or displace/reposition the agro-photovoltaic module 100 or part thereof (such as bottom unit 140 or water tank 110). In most cases, after the agro-photovoltaic module 100 has been filled with the growing bed, water or when plants have started to grow, its total weight may prevent unintentional movement. Nonetheless, when necessary to reposition the agro-photovoltaic, e.g. due to change of weather or the scenery (such as shading of a new tree or building), agricultural or industrial machinery, such as forklifts, tractors, truck or cranes may be of such an assistance.

FIG. 1C illustrate a construction of bottom unit 140 by detachably attaching the growing tray 120 with the water tank 110. As illustrated the growing tray 120 is configured for being nested within the water collecting tank 110, such that side walls 114 support at least a portion of side walls 124 and lever 118 supports at least a portion of bottom surface 122, therefore no additional securing members are required. However, when the growing tray 120 is not nested within the water tank 110, securing members, such as a snap fit, a locking pin and/or clip and/or other securing member which can enable quick release and activation thereof, which can be used to ensure that after attachment, growing tray 120 may not be moved with respect to water tank 110. In this example, when the growing tray 120 is formed separately from the water collecting tank 110, the manufacturing of each unit, i.e. growing tray 120 and/or water tank 110, can be done e.g. by using a variety of manufacturing technologies and combinations thereof, such as injection molding, vacuum-forming, thermo-forming, blow-molding, any combination thereof, etc.

It should be noted that, when each unit, i.e. growing tray 120 and/or water tank 110, is manufactured separately, the growing tray 120 can be configured for stackable nesting into like growing trays, such as growing tray 320 illustrated in FIG. 3. Accordingly, water collecting tank 110 can be configured for stackable nesting into like water collecting tanks, such as water tank 310 illustrated in FIG. 3. These stackable nesting characteristics can reduce the total footprint of the unconstructed modules, which in turn can reduce costs, e.g. when stored and/or when shipped.

FIG. 2A illustrates a cross section of a bottom unit 240a, which comprises growing tray 220a and water collecting tank 210a, unit 240a or any part thereof is similar to unit 140 or any part thereof. However, in this embodiment the growing tray 220a and the water collecting tank 210a are formed together into bottom unit 240a, e.g. by using a Rotation Molding technique or any other manufacturing technique. Manufacturing bottom unit 240a instead of manufacturing the water collecting tank 110 and the growing tray 120 separately as detailed hereinabove, may be more cost effective and can also facilitate easier displacement and/or movement of the units as a whole. When formed together, i.e. as bottom unit 240a, the water collecting tank 210a is configured for being stackable nesting into like growing trays 320 which, in turn are configured to receive therein the water collecting tank 210a, as illustrated in FIG. 3. This is also true for growing trays 120 or water tanks 110 which are also configured for being stackable nesting into like growing trays 320 or like water tanks 310.

FIG. 2B illustrates a cross section of a bottom unit 240b, which comprises growing tray 220b and water collecting tank 210b, unit 240b or any part thereof is similar, at least in their general functionality, to unit 140 or any part thereof. However, in this embodiment the growing tray 220b is divided into multiple individual growing units 221, such that each individual growing unit 221 is submerged into water tank 210b and has at least one hole which enables water to enter the individual growing unit 221, thereby “flooding” the unit. Individual growing units 221, are usually aimed for hydroponic growth. In this embodiment, the growing bed can be semi-liquid, moist or liquid for enabling hydroponic growth of plants. At least one drainage port 226b is disposed at each individual growing unit 221b. In most cases more than one drainage ports 226b are disposed for each individual growing unit 221b to enable continuous water circulation from and to the water collecting tank 210b. Although not illustrated, in some embodiments, the bottom unit as a whole can enable aquaponic growth of fish, e.g., when the growing tray is fully submerged into the water tank or by canceling growing tray and optionally extending the total size of the water tank. In this example and when forming a system comprising at least two agro-photovoltaic modules, i.e. when at least one growing tray is fully submerged into the water tank or canceled to enable aquaponic growth of fish, the aquaponic bottom unit can be connected to other bottom units aimed for use with solid, semi-solid, semi-liquid or liquid growing bed to enable these bottom units to use natural fertilized water, produced by the fish.

FIG. 3 illustrates stackably nesting unit 140, on top of like unit 340, comprising the growing tray 120 and water tank 110, it should be noted that other bottom units of other modules can also be stackable and/or nesting in bottom unit 340 or other like bottom units. When stacking several bottom units 140 together, the water collecting tank 110 is nested within like growing tray 320, such that at least a portion of bottom surface 112 or side walls 114 of the water collecting tank 110 is supported by like bottom surface 322 or like side walls 324 of like growing tray 320. The stackable nesting characteristics can reduce the total footprint of the unconstructed modules, which in turn can reduce costs, e.g. when stored and/or when shipped.

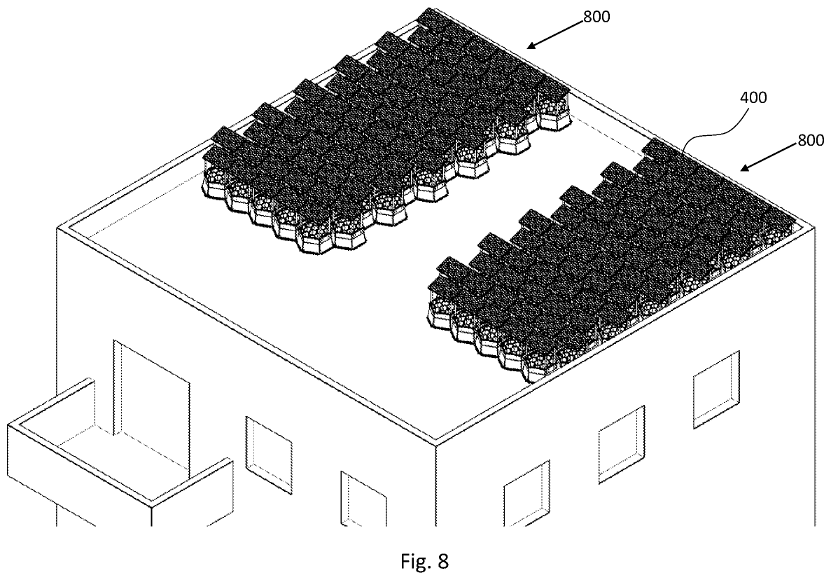

FIGS. 4A to 5B illustrate an agro-photovoltaic module generally designated 400 having a general hexagon shape, according to an example of the disclosure. Although the agro-photovoltaic module 400 has a general hexagon shape, the module 400 and parts thereof are similar in their functionality to the agro-photovoltaic module 100 and its parts thereof disclosed hereinabove. For example, water tank 410 along with side walls 414, bottom surface 412 and water port 416, etc., are equivalent in their functionality to water tank 110 and the elements comprising it such as side walls 114, bottom surface 112 water port 116 etc. Additionally, photovoltaic cell 430 and rods 432 are equivalent to photovoltaic cell 130 and rods 132, and growing tray 420 is equivalent in its general functionality of holding the growing bed and growing plants therein to growing tray 120. The hexagon shape, enables the agro-photovoltaic module 400 along with like modules to form a hive like system, as illustrated in FIG. 8, which has a better spacing efficiency than other shapes. Connecting elements 418, are disposed at the bottom of most of side walls 414. Connecting elements 418 are configured to connect the agro-photovoltaic module 400 to like modules, thereby preventing them from moving with resect to each other. In this embodiment, each connecting element 418 has a hollow elevated section configured for being inserted into link hollow elevated section of like modules or vise versa.

In this example, FIG. 5B illustrates that growing tray 420 is divided into multiple individual growing units 421, although not illustrated growing units 421 have at least two water holes that enable a “water connection” between the growing units 421 which in turn enables water to flow freely from one unit 421 to the other. In some embodiments, units 421 are formed without the water holes and each unit 421 acts by its own as a small growing tray. Individual growing units 421, are usually aimed for growing delicate plants, such as flowers, unlike growing units 221 illustrated in FIG. 2B which are mainly designed to facilitate hydroponic growth. It should be noted that although growing units 221 growing unit 421 are target different growing techniques they are similar at least in their functionality.

Air hole 429 is configured at an upper portion of the water tank 410 thereby enabling air to enter or exit the water tank 410, as detailed with respect to air hole 129.

FIG. 5B clearly illustrates sockets 428 which are configured for detachably attaching rods 432 to bottom unit 440. Rods 432 can be easily inserted into sockets 428 and/or removed, e.g. by pulling them out, from sockets 428, i.e. detaching photovoltaic cell 430 from bottom unit 440. It should be noted that other forms of detachably attaching photovoltaic cell 430 to bottom unit 440, e.g. via rods 432, can be done, for example, screw mounting rods, metal profiles, etc.

Reference is now made to FIGS. 6A to 6C, which illustrate an agro-photovoltaic module, generally designated as 600 can float on water, such as a water reservoir, e.g. lakes, fish ponds, treated or rain collecting water reservoirs or like reservoirs. This may be achieved due to a fitted design of the module 600 or any part thereof, e.g. having a floating design, the material used during production, such as floatable material and/or by using a floating arrangement which may be connected to the agro-photovoltaic module 600 as a whole or to any part thereof. In this example, module 600 further comprises floating arrangement 650 configured to support bottom unit 640 and to float on water, floating arrangement 650 enables positioning the agro-photovoltaic module 600 in water reservoirs thereby increasing their “usable areas”. For example, floating arrangement 650 enables agricultural growth and the production of energy, e.g. by using growing tray 620 and photovoltaic cell 630, on areas which where not available for agricultural use, prior to the use of module 600. Floating arrangement 650 is generally hollowed and sealed, thereby using the air “trapped” inside for increasing floating capabilities. Additionally, the floating arrangement 650 is made of a material that floats on water, such as plastic, wood or any other floating material. The floating arrangement 650, in general, is designed to frame bottom unit 640 by side walls 654 which form a confined basin 655 preventing bottom unit 640 from drifting away. Bottom surface 652 is designed to support bottom unit 640 so that it will not sink in the water, e.g. by providing at least one resting point 651, configured to support the water tank's bottom surface 612. In this example, resting point 651 is slightly elevated with respect to the rest of bottom surface 652. Additionally, bottom surface 652 has openings 653 which enable water to enter basin 655 thereby surrounding bottom unit 640 at least from its side walls 614 and bottom surface 612.

In this embodiment, bottom unit 640 is configured to pivot with respect to the floating arrangement 650 for example along a horizontal reference plane of module 600, e.g. by hand or a motor. Pivoting bottom unit 640 can help increase the effective lighting that reaches the growing tray 620 and/or photovoltaic cell 630 which in turn can increase the power generated by it. For example, since photovoltaic cell is detachably attachable to bottom unit 640, e.g. by rods, 632, pivoting bottom unit 640 pivots in turn photovoltaic cell 630, which enables the growing tray 620 and the photovoltaic cell 630 to “follow the sun”. This “following the sun” ability may be done manually or by a motor, e.g. according to a predetermined optimization program, such as a computer program/algorithm or other predefined algorithm, configured to optimize the production of energy and/or agricultural growth.

When water enter basin 655, they help to reduce the friction between the bottom unit 640 and floating arrangement 650, which in turn also reduce the power required to pivot bottom unit 640 with respect to the floating arrangement 650. Reducing the power required for pivoting, e.g. by a motor, results in less power required to operate the agro-photovoltaic module 600, enabling more of the produced power to be available for external use e.g., an external power grid, a battery, an end user any combination thereof or any other electrical energy transporting, consuming or storing device.

Since bottom unit 640 nests within basin 655 and they are two separate elements, bottom unit 640 is also pivotable with respect to the like modules or like bottom units attached to module 600, e.g., via floating arrangement 650, e.g., when forming a floating system which comprises multiple modules 600. It should be noted that the agro-photovoltaic module 600 can also be used on a “hard” surface such as ground or rooftops. Thereby, when being part of a system, each photovoltaic cell 630 and growing tray 620 can be pivoted individually, with respect to the rest of the bottom units in the system. In other embodiments bottom unit 640 or water tank 610 may not be pivoted with respect to the floating arrangement 650, e.g. when the water tank 610 and the floating arrangement 650 are formed as one unit.

In this example, the agro-photovoltaic module 600 comprises a pivoting element 634, which enables photovoltaic cell 630 to be pivoted at an angle with respect to bottom unit 640, i.e. along the vertical plain of the agro-photovoltaic module 600. Pivoting element 634, enables further adjustment of the photovoltaic cell 630, e.g. to better “follow the sun” as detailed hereinabove and/or to increase and/or decrease the shelter provided to the plants growing in growing tray 620 by photovoltaic cell 630.

In some embodiments, e.g. when the water tank 610 is formed along with floating arrangement 650, bottom unit 640 may not pivot with respect to floating arrangement 650. When growing tray 620 and accordingly photovoltaic cell 630 can not pivot with respect to the floating arrangement 650 there may not be any additional adjustments of the photovoltaic cell 630, such as “following the sun” function detailed hereinabove.

Although in this embodiment growing tray 620 is illustrated as having individual growing units similar to growing units 421 and/or 221 it may also be similar to growing tray 120, all the detailed hereinabove embodiments may comprise an air hole 629 is disposed at an upper portion of the water tank 610 thereby enabling air to enter or exit the water tank 610, as detailed with respect to air hole 129.

Although not illustrated, in some embodiments, e.g. when used for hydroponic growth, the agro-photovoltaic module 600 may not comprise a water tank at all. Accordingly, bottom surface 652 can therefore be designed to support growing tray 620 so that it will not sink in the water, e.g. by providing at least one resting point 651, configured to support the growing tray's bottom surface. In this embodiment, the plants growing in the growing tray 620 can receive there water directly from the water reservoir, e.g. by having their roots submerged or at least touch the water within the water reservoir.

FIGS. 7 and 8 illustrate systems 700 and 800 respectively, each system comprises multiple agro-photovoltaic modules as described hereinabove. It should be notated that although in this examples system 700 is comprised solely of multiple agro-photovoltaic modules 100 and system 800 is comprised solely of multiple agro-photovoltaic modules 400, a system comprising of at least two agro-photovoltaic modules, can be comprised of any combination of agro-photovoltaic modules 100, agro-photovoltaic modules 400 or like agro-photovoltaic modules. Each system enables the photovoltaic cells, such as 130, 430 and/or like, of each of the modules 100, 400 and/or like to be connectable by there own and/or as part of the system 700, 800 and/or like to the external electric power system, such that at least a majority of the energy produced by the photovoltaic units in the system is directed to an external use, with respect to the elements comprising the system. It should be noted that when forming a system of agro-photovoltaic modules 100, 400 and/or like, it is preferable that the photovoltaic cells are connected to form a series circuit, a parallel circuit or series of any combination thereof which can then be connected to the external electric power system thereby increasing the voltage and/or current produced by the system 700, 800 and/or like, e.g. according to the requirements of the external electric power system.

FIG. 7 illustrates a plantation that integrates system 700, which comprise multiple agro-photovoltaic modules 100 distributed, e.g. by a tractor, between the trees. By integrating system 700 into the plantation, the effective use of the available land space is increased, e.g. in an agricultural manner (use of growing trays 120 to grow plants) and energy wise.

In some embodiments agro-photovoltaic modules 100 of system 700 may not contain growing tray 120 but solely photovoltaic cell 130 and water tank 110. For example, to collect rainwater that would be collected in water tanks 110, which will be used to water the trees in the plantation. It should be noted that the agro-photovoltaic modules of system 700 can be connected to each other and/or to an external water collecting tank (not illustrated), e.g. via water port 116. When system 700 is connected to the external water tank, the water stored water in each agro-photovoltaic module can be collected, e.g. via a pump, to the external water tank. Additionally, when system 700 is connected to the external water tank, water stored within the external water tank can be distributed to each agro-photovoltaic module in system 700 when needed.

FIG. 8 illustrates positioning system 800 on top of a roof of a building, e.g. by positioning multiple agro-photovoltaic modules 400 adjacent to each other. Since agro-photovoltaic modules 400 have a general hexagon shape, system 800 has a general hive shape. Positioning system 800 on top of a roof my have several advantages on top of utilizing the space for the production of energy and/or growing plants. For example, the use of system 800 may further provide thermal and acoustic insulation for the building. Additional, since growing trays 420 and water tanks 410 also collect rainwater during rain events, the use of system 800 in the urban area can decrease the water load onto the municipal drainage system.

Thereby, using systems 700, 800 or like systems enables to utilize any unused space, whether it is out in the open, within a plantation or on top of a roof, and may have additional benefits to the area at which they are disposed at. It should be noted that the agro-photovoltaic modules of system 700, 800 may be positioned at a verily of locations, such as: landfills, contaminated fields, municipal areas, roadsides, young plantations and like areas which have not been used for agricultural purposes for temporary and/or permanent reasons.

It should be noted that any one of the particular examples described hereinabove with respect to the agro-photovoltaic modules (100, 400 and/or 600) parts thereof and/or systems 700 and 800 can be implemented, mutandis mutatis, in any one of the other modules, parts thereof or systems which may comprise at least two agro-photovoltaic modules, even if not specifically addressed and/or disclosed hereinabove. For example, a system, such as system 700 and/or 800 may comprise different agro-photovoltaic modules. Some modules may comprise a battery for storing the collected energy, whereas other modules may not compose a photovoltaic cell. Some modules in the system may be used for aquaponic growth while others may be used for agricultural growth by using a growing bed and/or hydroponic growth.

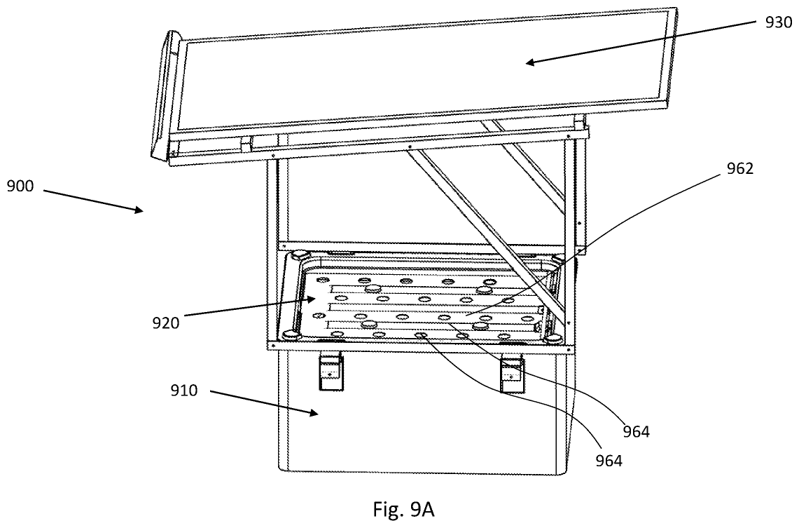

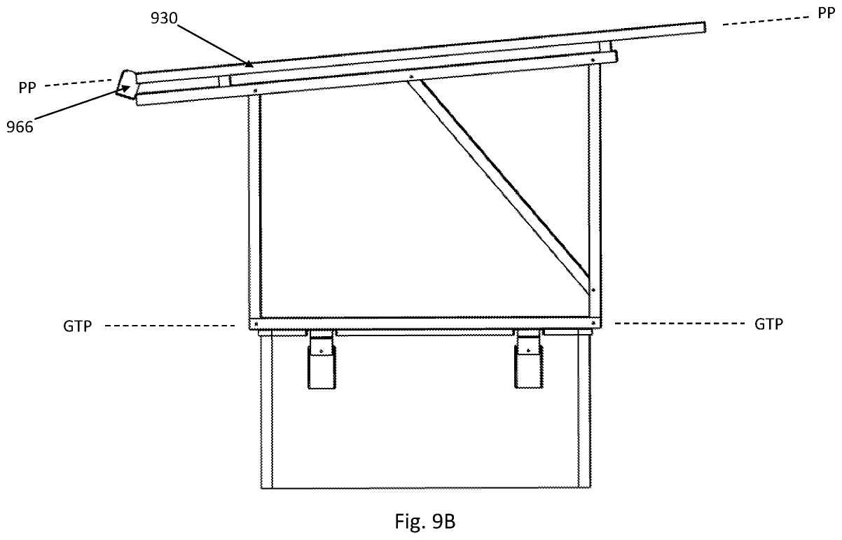

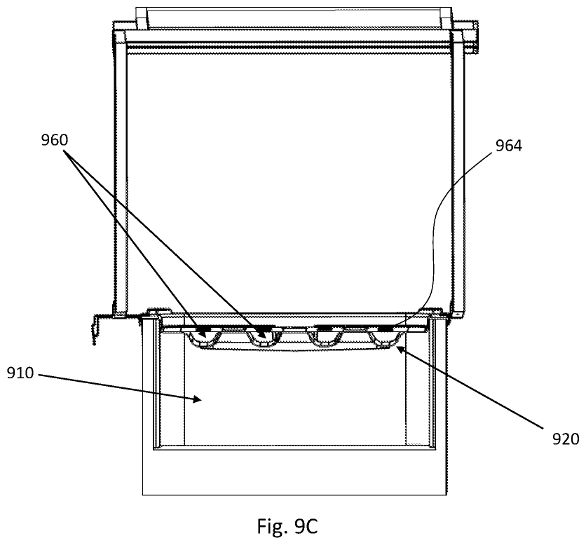

Reference is now being made to FIGS. 9A-9C, which are schematic illustrations of different views of a non-limiting example of the agro-photovoltaic module according to an aspect of the present disclosure. The figures exemplify an agro-photovoltaic module 900 that comprises a water collection tank 910 for storing and collecting water. A growing tray 920 is mounted above the water collection tank 910 and is formed with watering tunnels 960 for placing plants to be grown therein to receive constant water provision in a hydroponic growing method. Each watering tunnel is designed to provide water for a plurality of plants. The watering tunnels 960 receives water supply from the collection tank 910, e.g. via circulating pumps. A perforated cover 962 is fitted over the growing tray 920 such that the perforations 964 are arranged along the watering tunnels 962 to allow the plants to grow therethrough while the rest of the watering tunnels portions are covered to avoid unwanted evaporation of water. The perforated cover 962 can be coated by a reflective material to reflect light to be received by the plants growing in the growing tray 920 or by a photovoltaic cell 930 that is mounted above the growing tray 920. The photovoltaic cell 930 is mounted on upper end of posts 932. The bottom ends of the posts 932 are coupled directly or indirectly to the body portion of the agro-photovoltaic module 900 that constitutes the growing tray 920 and/or the water collecting tank 910. The photovoltaic cell 930 defines a photovoltaic plane PP that is inclined at an angle α with respect to a growing tray plane GTP defined by the growing tray and is parallel to the ground. The angle α can be between 2°-30° or between 2°-10° or about 5°. Thus, water that falls on the photovoltaic cell 930 flows towards its bottom part and being collected there by a water draining element 966 that circulates the water either to the growing tray or to the water collecting tank 910.

The term “about” should be interpreted as a deviation of ±20% of the nominal value. For example, if the value is about 10, thus it should be understood to be in the range of 8-12.

The photovoltaic cell 930 can be two-sided, namely that the production of photovoltaic energy is performed from two sides of the photovoltaic unit. Thus, reflections of light from the reflective material of the perforated cover 962 can be received in the bottom side of the photovoltaic cell to produce photovoltaic energy.

1. An agro-photovoltaic module comprising:
a growing tray having a bottom surface and circumferential side walls, configured to facilitate a growing bed for enabling the growth of one of plants or animals; and
a photovoltaic cell positionable over said growing tray, configured to produce photovoltaic energy.

2. The agro-photovoltaic module of claim 1, further comprising a water collecting tank configured to store water therein, wherein said water collecting tank is positioned beneath said growing tray to enable water to drain from said tray to said tank.

3. The agro-photovoltaic module of claim 2 wherein, said growing tray is configured for stackable nesting into like growing trays or said water collecting tank is configured for stackable nesting into like water collecting tanks or wherein said growing tray is configured for stackable nesting into said water collecting tank, or vise versa.

4. The agro-photovoltaic module of claim 2, wherein said growing tray is rotatable with respect to the water tank.

5. The agro-photovoltaic module of claim 2, wherein said water tank has circumferential side walls, wherein said growing tray is contained within said water tank side walls.

6. The agro-photovoltaic module of claim 2, comprises one or more water ports for allowing flow of water between the water collecting tank and at least one of like water collecting tanks, growing trays, a water feeding line and/or a big collection water tank, the flow of water is either (i) unidirectional, or (ii) bi-directional, such that water can flow from and into the collecting tank.

7. The agro-photovoltaic module of claim 2, being connectable to a like agro-photovoltaic module either through liquid communication by one or more water ports or through an electrical connectivity in series or parallel, or through a combination of the two connection types.

8. The agro-photovoltaic module of claim 2, being connectable via a first port to a first water source including biological matter, and via a second port to a second water source to discharge processed water after passing through the growing tray.

9. The agro-photovoltaic module of claim 8, further comprises one or more pumps for circulating water from the water collecting tank to the growing tray.

10. The agro-photovoltaic module of claim 2, wherein photovoltaic cell is inclined to define a bottom part of the photovoltaic cell, wherein the bottom part of the photovoltaic cell comprises a water draining element for draining the water flowing over the photovoltaic cell and direct them to either the water collecting tank or the growing tray.

11. (canceled)

12. The agro-photovoltaic module of claim 1, wherein said photovoltaic cell is connectable to like photovoltaic cells to form a series circuit, a parallel circuit or series of any combination thereof.

13. (canceled)

14. (canceled)

15. (canceled)

16. (canceled)

17. (canceled)

18. (canceled)

19. The agro-photovoltaic module of claim 1, further comprises a processing circuitry and one or more sensors for sensing at least one of: temperature, humidity, water level in the collecting tank and state of the photovoltaic cell, wherein the processing circuitry is configured for controlling at least one of: water inflow/outflow of the system, climate conditions and photovoltaic cell state in response to the measurement received by said one or more sensors.

20. The agro-photovoltaic module of claim 1, wherein the growing tray further comprises watering tunnels for providing constant water supply to plants growing thereon.

21. The agro-photovoltaic module of claim 1, further comprises a perforated cover mounted on the growing tray, the perforations of the cover are configured for fitting over the plants in the growing tray to allow them to be exposed to the environment.

22. The agro-photovoltaic module of claim 21, the perforated cover comprises a photovoltaic facing face that comprises or coated by a reflecting material that is configured to reflect a selected range of electromagnetic radiation.

23. The agro-photovoltaic module of claim 21, wherein the growing tray further comprises watering tunnels for providing constant water supply to plants growing thereon and the perforations of the perforated cover are arranged along the watering tunnels to define growing spots for plants.

24. The agro-photovoltaic module of claim 1, wherein a majority of said produced photovoltaic energy is directed to an external electric power system.

25. The agro-photovoltaic module of claim 24, wherein said photovoltaic cell is connectable to said external electric power system.

26. A system comprising at least at least two agro-photovoltaic modules according to claim 1, wherein the photovoltaic cell of each of the modules is connectable to the electric power system; and wherein the photovoltaic cells of the modules are connectable to each other to form a series circuit, a parallel circuit or series of any combination thereof, and said circuit is connectable to the external electric power system.

27. (canceled)

28. (canceled)

29. (canceled)

30. An agro-photovoltaic module comprising:
a growing tray having a bottom surface and circumferential side walls, configured to facilitate a growing bed for enabling the growth of plants;
a photovoltaic cell positionable over said growing tray, configured to produce photovoltaic energy;
a water collecting tank configured to store water therein, wherein said water collecting tank is positioned beneath said growing tray to enable water to drain from said growing tray to said water collecting tank; and
wherein the agro-photovoltaic module further characterized by at least one of: (i) comprising a water port for allowing flow of water between the water collecting tank and at least one of like water collecting tanks, growing trays, water source, and/or a big collection water tank; and/or (ii) wherein said photovoltaic cell is connectable to like photovoltaic cells to form a series circuit, a parallel circuit or series of any combination thereof.
